(19) United States
(12) Patent Application Publication
(10) Pub. No.: US 2009/0286426 A1
(43) Pub. Date: Nov. 19, 2009

(54) Connector for the network device

(76) Inventors: Chi-Chih Liao, Hsin-Chu (TW); Hung Hsun Lan, Hsin-Chu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/230,644

(22) Filed: Sep. 3, 2008

(30) Foreign Application Priority Data
May 15, 2008 (TW) 097117869

(51) Int. Cl. H01R 24/04

(52) U.S. Cl. 439/668

(57) ABSTRACT

A connector for the network device comprises a connecting body and a plurality of pins. The connecting body comprises a first side and a second side, and the pins comprise a first row of pins and a second row of pins, wherein the first row of pins are provided with the first side, and the second row of pins are provided with the second side, and further, both of which comprise a plurality of negative pins and positive pins, wherein the negative pins and positive pins are spread within the first row of pins and the second row of pins alternately and evenly. Each of negative pins and adjacent positive pins are combined to be a connecting port in turn with horizontal symmetry type, such that the interference between the connecting ports can be restrained efficiently, thereby, the transmission efficiency for the network device will be improved accordingly.

### BACKGROUND OF THE INVENTION

1. Technical Field

The present invention is related to a connector for the network device, more particularly to a connector for the network device that can improve the transmission efficiency since the interference between the connecting ports has been restrained.

2. Description of the Prior Art

Referring to FIG. 1, a block diagram illustrating the structure of a prior art connector for the network device is showed. The connector 10 comprises a connecting body 11 and a plurality of pins 13. The connecting body 11 comprises a first side 111 and a second side 113, and the pins 13 comprise a first row of pins 131 and a second row of pins 133.

The first row of pins 131 are provided with the first side 111, and the second row of pins 133 are provided with the second side 113, wherein the amounts of the first row of pins 131 and the second row of pins 133 are the same, and the first row of pins 131 comprise a plurality of negative pins (V−) 135, the second row of pins 133 comprise a plurality of positive pins (v+) 137. Furthermore, the first row of pins 131 further comprise a first idle pin 136, and the second row of pins 133 further comprise a second idle pin 138.

The prior art connector 10 is with the negative pins 135 and positive pins 137 that are respectively provided within the first row of pins 131 and the second row of pins 133, and further, the prior art connector 10 is with adopting vertical symmetry type (Vertical type, V-type) for combining pins to be the connecting ports 139, that is, the negative pins 135 in the first row of pins 131 and the positive pins 137 in the second row of pins 133 are combined to be the connecting ports 139, wherein the negative pins 135 and positive pins 137 are provided with vertical symmetry type. For example, the negative pin (2) in the first row of pins 131 and the positive pin (27) of the second row of pins 133 are combined to be a connecting port (port 0). Therefore, each negative pin 135 and the corresponding positive 137 can be combined to be 24 connecting ports 139, as shown on FIG. 1.

According to the general connector, such as RJ-21 connector, the interval distance between two adjacent pins thereof is only 1.25 pin pitches, therefore, once the interval distance between the same adjacent positive pins 137 or negative pins 135 is too close, the cross talk effect would be occurred while the network device is transmitting data or testing, such as the full load test, thereby, the signal interference between connecting ports will affect the data transmission efficiency. Thus, since the prior art connector 10 is with adopting vertical symmetry therein for pin assignment, the pins having the same polarity will increase the noise interference effect.

Due to the noise interference should be prevented, the prior art connector 10 for network device has to be more with the noise restraining enhancement function providing on the rear end circuit therein, otherwise, two connectors can be considered according to another option for reducing the network transmission error since the noise interference is occurred. Accordingly, the circuit design will be difficult and the manufacturing cost of the network device will be increased since the foregoing solutions are implemented.

### SUMMARY OF THE INVENTION

It is therefore a primary object of the present invention to provide a connector for the network device, adopting with horizontal symmetry type for combining pins to be the connecting ports, which are combined by a plurality of negative pins and positive pins, wherein each of negative pins is provided with the adjacent negative pin horizontally with the same row, thereby, the interference between connecting ports can be restrained, and further, the transmission efficiency of the network device can be improved.

It is a secondary object of the present invention to provide a connector for the network device, which is without additional circuit design or manufacturing cost, but the interference restraining function can be improved for the network device, thereby, it is convenient for manufacturing of the network device.

It is another object of the present invention to provide a connector for the network device, adopting with horizontal symmetry type for combining pins to be the connecting ports, wherein each of negative pins and positive pins are spread within the first row of pins and second row of pins evenly, thereby, the interval distance between each of pins can be enlarged for preventing the cross talk effect, wherein the pins are with the same polarity.

According to the above objects, a connector for the network device is provided, comprising a connecting body, comprising a first side and a second side; and a plurality of pins, comprising a first row of pins and a second row of pins, wherein the first row of pins are provided with the first side, and the second row of pins are provided with the second side, wherein the first row of pins and the second row of pins comprise a plurality of negative pins and positive pins, wherein the amounts of the negative pins and positive pins are the same, wherein the negative pins and positive pins are spread within the first row of pins and the second row of pins evenly and horizontal alternately, wherein a plurality of connecting ports are combined by the negative pins and the positive pins in turn, wherein the positive pins are adjacent with the negative pins horizontally.

The present invention can be best understood through the following description and accompanying drawings.

### BRIEF DESCRIPTION OF THE DRAWINGS

FIG. 1 is a block diagram illustrating the structure of a prior art connector for the network device;

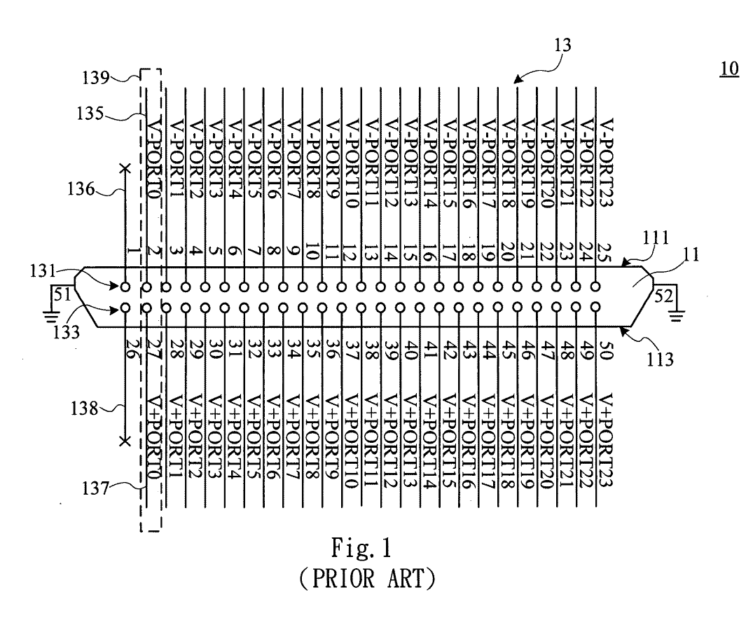

FIG. 2 is a block diagram showing the structure of a network device according to the preferred embodiment of the present invention;

FIG. 3 is a block diagram showing the structure of a connector for the network device according to a preferred embodiment of the present invention;

FIG. 4 is a block diagram showing the structure of a connector for the network device according to another preferred embodiment of the present invention;

FIG. 5 is a block diagram showing the structure of a connector for the network device according to another preferred embodiment of the present invention;

FIG. 6 is a block diagrams showing the structure of a connector for the network device according to another preferred embodiment of the present invention;

FIG. 7 is a chart showing the attenuation according to the connecting port of the connector being with vertical symmetry type; and

FIG. 8 is a chart showing the attenuation according to the connecting port of the connector being with horizontal symmetry type.

### DETAILED DESCRIPTION OF THE PREFERRED EMBODIMENTS

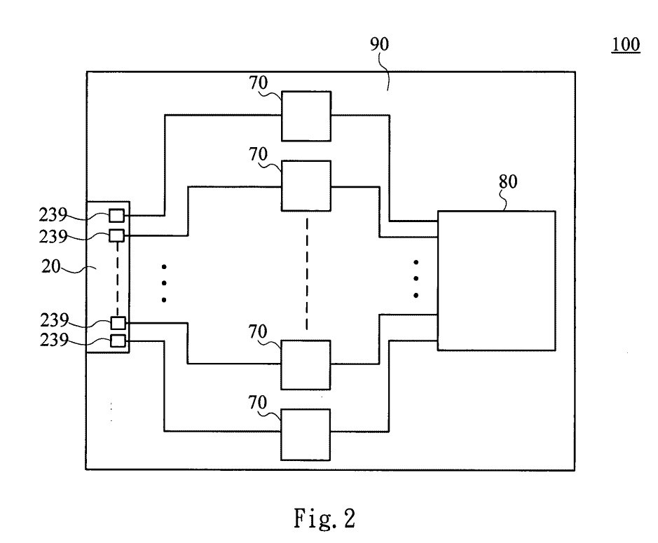

Referring to FIG. 2, a block diagram showing the structure of a network device according to the preferred embodiment of the present invention is disclosed. The network device 100 comprises a connector 20, a plurality of line drivers 70, and a process unit 80. The connector 20 comprises a plurality of connecting ports 239, wherein each of connecting ports 239 is connected to a corresponding line driver 70, and each of line drivers 70 is connected to the process unit 80, and further, the connector 20, line drivers 70, and process unit 80 are provided on a circuit board 90.

The process unit 80 is used for controlling each of line drivers 70 to drive the corresponding connecting port 239 in the connector 20, thereby, the network signal can be received and transmitted through the connecting ports 239, and the process unit 80 can process operation for the network signal.

The network device 100 is applied on an X Digital Subscriber Line (XDSL), such as a Very High Data Rate DSL (VDSL), Asymmetric DSL (ADSL), Symmetric DSL (SDSL), or High Data Rate DSL (HDSL).

The connector 20 is a RJ-21 connector (or named TELCO 50), comprising 50 pins, wherein there are 24 connecting ports according to the combination of pins. The connecting ports 20 are as the interface for the external network connection of the network device 100.

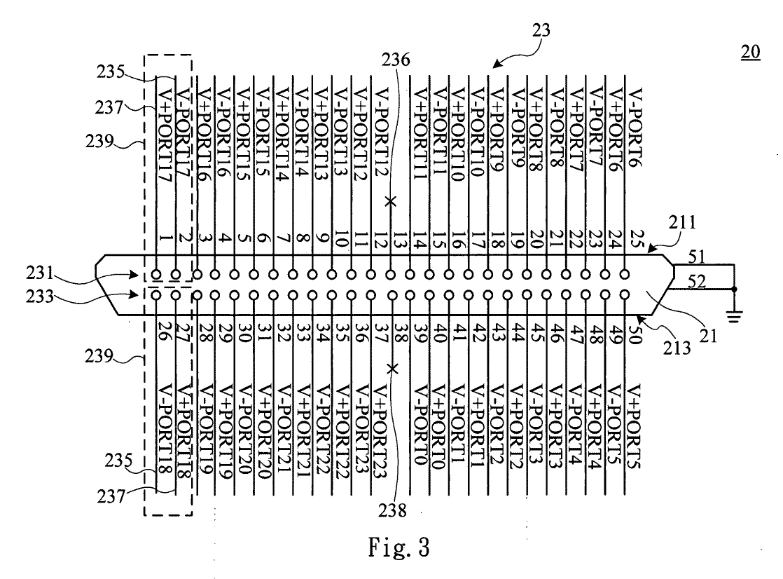

Referring to FIG. 3, a block diagram showing the structure of a connector for the network device according to a preferred embodiment of the present invention is disclosed. The connector 20 comprises a first side 211 and a second side 213, and pins 23 comprise first row of pins 231 and second row of pins 233.

The first row of pins 231 are provided with the first side 211, and the second row of pins 233 are provided with the second side 213. The amounts of pins 23 with respect to the first row of pins 231 and second row of pins 233 are the same.

The first row of pins 231 and second row of pins 233 respectively comprises a plurality of negative pins (V−) 235 and positive pins (V+) 237, each of negative pins 235 and positive pins 237 are spread within the first row of pins 231 and second row of pins 233 evenly and horizontal alternately, that is, if one of pins 23 is the negative pin 235, then another horizontal adjacent pin 23 provided on the same row is the positive pin 237.

The connector 20 is with adopting the horizontal symmetry type (Horizontal type, H-type) for combining pins to be the connecting ports, that is, each of negative pins 235 and positive pins 237 are combined to be a connecting port 239, wherein each of positive pins 237 is provided with the adjacent negative pin 235 horizontally with the same row. For example, the negative pin (2) and the adjacent positive pin (1) of the first row of pins 231 are combined to be a connecting port (Port 17), or the negative pin (26) and the adjacent positive pin (27) of the second row of pins are combined to be a connecting port (Port 18). Therefore, the negative pins 235 and positive pins 237 can be combined to be 24 connecting ports 239, wherein each of positive pins 237 is provided with the adjacent negative pin 235 horizontally.

Furthermore, the first row of pins 231 comprise a first idle pin 236, and the second row of pins 233 comprise a second idle pin 238, wherein the first idle pin 236 and the second idle pin 238 are absent for the combination of the connecting port.

As well as, according to the connector 20 of this embodiment, the beginning of polarity determination for the pins 23 is from the intermediate of the second row of pins 233. For example, the negative pin (39) and positive pin (40) of the second row of pins 233 are combined to be a connecting port (Port 0).

Since the connector 20 is with adopting H-type for combing pins to be the connecting ports 239, the interval distance between two pins that are with the same polarity can be enlarged surely. For example, the interval distance between the positive pin (1) and the positive pin (3) will be 2.5 pin pitches.

Therefore, while the network device 100 is transmitting data or processing full load test, the interference between connecting ports can be restrained efficiently since the effect of the cross talk has been reduced, thereby, the corrective of network data transmission can be improved accordingly. Additionally, it is convenient for manufacturing the network device 100 since more manufacturing cost and circuit design are unnecessary, as well as, the noise restraining function is improved for the network device 100.

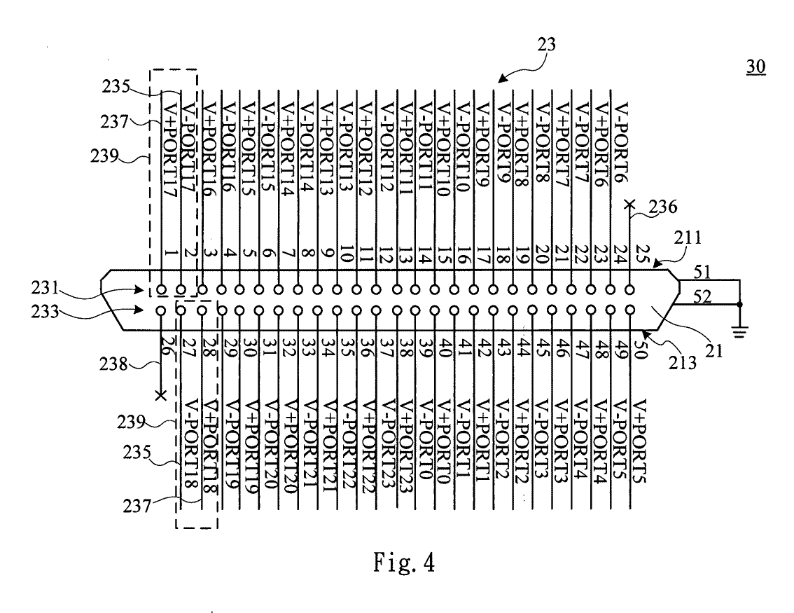

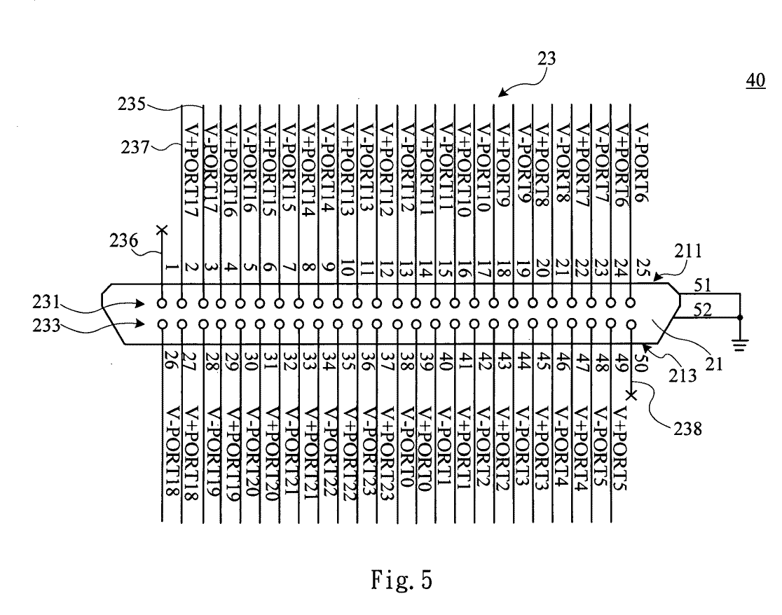

According to the connector 30 of another embodiment, the first idle pin 236 is provided on the latest pin (25) of the first row of pins 231, and the second idle pin 238 is provided on the primary pin (26) of the second row of pins 233, as shown on FIG. 4. Otherwise, according to the connector 40 of another embodiment, the first idle pin 236 is provided on the primary pin (1) of the first row of pins 231, and the second idle pin 238 is provided on the latest pin (50) of the second row of pins 233, as shown on FIG. 5.

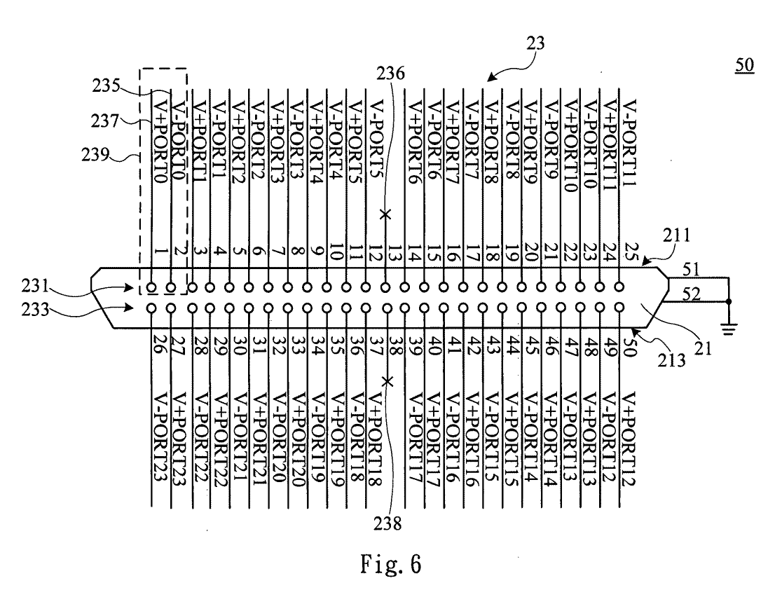

According to the foregoing description with respect to the connector 20 of the embodiment shown on FIG. 3, the beginning of polarity determination for the pins 23 is from the intermediate of the second row of pins 233. Nevertheless, according to the connector 50 of another embodiment, the primary pins (1) and (2) of the first row of pins 231 are the beginning pins for combining to be the connecting port (Port 0), as shown on FIG. 6.

Moreover, the connectors 20, 30, 40, and 50, are part of embodiments according to the present invention, therefore, the position and order of the connecting port 239, first idle pin 236, and second idle pin 238 can be altered depending on the consideration of the practical circuit layout, as well as, it improves the noise restraining function for the network device 100.

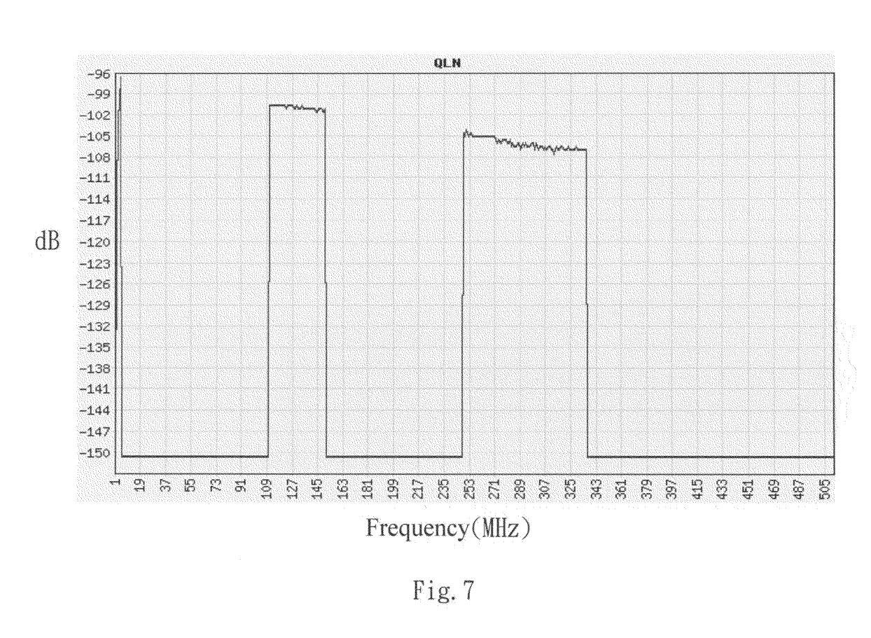

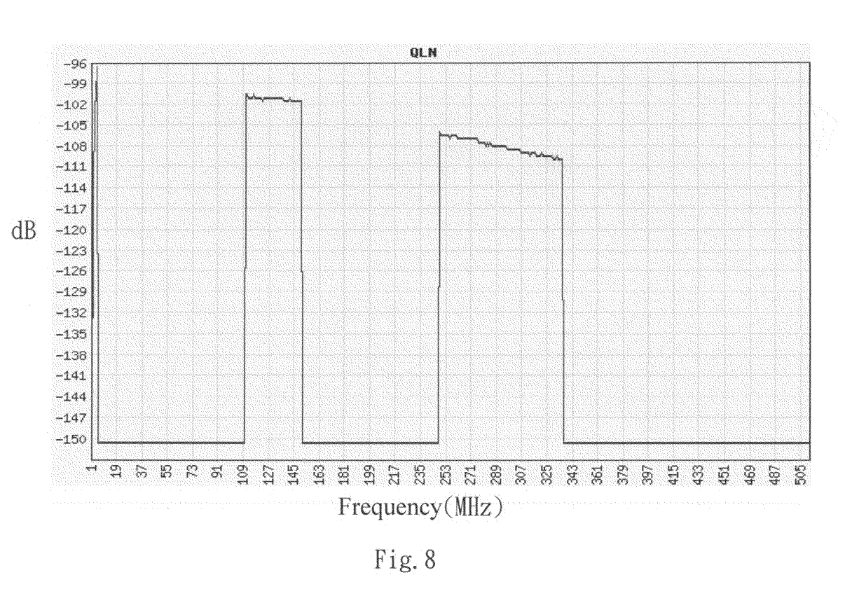

Referring to FIG. 7 and FIG. 8, charts showing the attenuation according to the connecting port of the connector being with vertical symmetry type and horizontal symmetry type are disclosed. The network device comprises the connector that is with adopting V-type for combining pins to be the connecting ports, wherein the attenuation during low frequency operation is around −100 dB to −101 dB, and the attenuation during high frequency operation is around −104 dB to −107 dB, as shown on FIG. 7.

The network device comprises the connector that is with adopting H-type for combining pins to be the connecting ports, wherein the attenuation during low frequency operation is around −100 dB to −101 dB, and the attenuation during high frequency operation is around −106 dB to −110 dB, as shown on FIG. 8.

Comparison with two charts, the difference between both for low frequency operation is the same or very small; however, since the frequency is getting higher, the dB value of the attenuation with respect to H-type is lower than the attenuation with respect to V-type, that is, the connector with horizontal symmetry type is better for restraining noise. Furthermore, while the network device is processing the full load test, the most up stream is 22.661 Mbps and down stream is 74.179 Mbps for V-type adopted, however, according to H-type adopted, the most up stream is 24.227 Mbps and down stream is 74.294 Mbps. Therefore, the connectors 20, 30, 40, and 50, disclosed on the foregoing embodiment of the present invention, are with adopting H-type for combining pins to be the connecting ports, can improve the noise restraining function and increase the network data transmission efficiency.

The above embodiments are only used to illustrate the present invention, not intended to limit the scope thereof. Many modifications of the above embodiments can be made without departing from the spirit of the present invention.

What is claimed is:

1. A connector for the network device, comprising:
a connecting body, comprising a first side and a second side; and
a plurality of pins, comprising a first row of pins and a second row of pins, wherein said first row of pins are provided with said first side, and said second row of pins are provided with said second side, wherein said first row of pins and said second row of pins respectively comprise a plurality of negative pins and positive pins, wherein the amounts of said negative pins and positive pins are the same, wherein said negative pins and positive pins are spread within said first row of pins and said second row of pins evenly and horizontal alternately, wherein a plurality of connecting ports are combined by said negative pins and said positive pins in turn, wherein said positive pins are adjacent with said negative pins horizontally.

2. The connector of claim 1, wherein said first row of pins further comprises a first idle pin, and said second row of pins further comprises a second idle pin, wherein said first idle pin and said second idle pin are absent for the combination of said connecting ports.

3. The connector of claim 1, wherein said network device is applied on an X digital subscriber line (XDSL).

4. The connector of claim 3, wherein said connector is applied for an external network connection.

5. The connector of claim 1, wherein said connector is a RJ-21 connector.

6. The connector of claim 1, wherein said connector is provided on a circuit board of said network device.

7. The connector of claim 1, wherein each of said connecting ports is respectively connected to a line driver.

8. The connector of claim 7, wherein each of said line drivers is respectively connected to a process unit.
